(19) United States
(12) Patent Application Publication
(10) Pub. No.: US 2017/0312930 A1
(43) Pub. Date: Nov. 2, 2017

(54) CUTTING TOOL

(71) Applicant: D-CUT PRODUCTS, INC., OAK BROOK, IL (US)

(72) Inventor: Charlie ZHANG, Oak Brook, IL (US)

(73) Assignee: D-CUT PRODUCTS, INC., OAK BROOK, IL (US)

(21) Appl. No.: 15/142,810

(22) Filed: Apr. 29, 2016

(51) Int. Cl. B26D 5/10; B26D 1/00; B26D 7/01

(52) U.S. Cl. CPC B26D 5/10; B26D 7/015; B26D 1/0006; B26D 2001/006

(57) ABSTRACT

A cutting tool for cutting sheets of materials, such as, for example, sheets of building materials. The cutting tool includes a working table with a support surface. The working table includes a slot extending through the support surface. The cutting tool further includes a handle and blade pivotally engaged with respect to the working table between an open position and a closed position. The cutting tool further includes a guide rail that can be connected to the base in a plurality of positions relative to a cutting plane of the blade include a parallel position and a perpendicular position.

### BACKGROUND OF THE INVENTION

### Field of the Invention

This invention relates to a cutting tool for cutting sheets of material, such as, for example, sheets of building materials. More specifically, this invention relates to a portable cutting tool including a base and a blade pivotally engaged with respect to the base and movable between an open position and a closed position and an adjustable guide rail that allows for alignment both perpendicular and parallel to a cutting plane of the blade.

### Discussion of Related Art

Certain building materials, such as, for example, flooring materials, are provided as sheets or planks of various dimensions. When used on a job site, the sheets or planks must be customized to meet the specific requirements of the job site. For example, the sheets or planks must be cut to fit around edges or corners of a room and/or around fixtures. Various tools are currently used to cut sheets of building materials, but most are bulky, heavy, require power to be operated, produce large amounts of dust during the cutting process, and/or result in uneven or splintered cuts.

There is a need or a desire for an improved cutting tool for cutting sheets or planks of building materials. There is a need or a desire for a portable, non-power operated cutting tool able to cut sheets of building materials in a predictable and straight fashion without splintering, cracking or similar problems and providing fast, dust-free cutting. There is further a need for a portable, non-power operated cutting tool that is capable of cutting building materials in both a transverse and longitudinal cutting position.

### SUMMARY OF THE INVENTION

The present invention provides a portable, non-power operated cutting tool for cutting sheets of building materials in a straight fashion without splintering or cracking. The cutting tool of this invention also includes a guide rail that can be mounted to a cutting platform to provide support both perpendicular and parallel to a cutting plane.

According to one embodiment of this invention, the cutting tool includes a base, a blade pivotally engaged with respect to the base and a handle connected to the blade at a position opposite the pivotal connection to the base. The base may further include at least one support member, for example, legs or support walls, for supporting the base before and during cutting. The base further includes a working table to support the building material while cutting. The handle and the blade pivotally movable with respect to the base between an open position and a closed position. The blade moves through a slot in the working table and works against an edge along the slot to cut the building material as the blade is moved to the closed position.

In a preferred embodiment of this invention, a guide rail can be connected to the working table to support the material during cutting to ensure a straight square cut. The working table may further includes a plurality of connectors for mounting one or more guide rails to the working table. In an embodiment of this invention, the connectors may comprise a plurality of holes in the working table and a plurality of complimentary posts extending from the bottom of the guide rail. However, it should be understood that alternative connectors known to one skilled in the art may be used including, but not limited to, threaded connectors, and tab and groove connectors. The posts of the guide rail can be aligned and pressed into to a subset of the plurality of holes to fix the guide rail in a position relative to the cutting plane of the blade. Preferably, the connectors allow the guide rail to be set in a transverse position (perpendicular to the blade) or in a longitudinal position (parallel to the blade). In an alternative embodiment, the connectors may be used to position the guide rail at any angle relative to the blade.

The blade of the cutting tool preferably includes a plurality of generally flat cutting surfaces arranged in a polygonal profile. Each generally flat cutting surface is preferably a straight segment. Each straight segment transitions into at least one other straight segment, and two adjacent straight segments form an angle of between about 90 degrees and 180 degrees.

In one embodiment of this invention, the working table includes a plurality of serrations to prevent movement of the building material during cutting. The plurality of serrations may be positioned along both edges of the working table directly adjacent of the slot. Alternatively or additionally, the working table may include a friction material positioned with respect to the slot.

The cutting tool of this invention may further include a handle stop extending from the handle toward the base and contacting the base when the handle is in the closed position.

### BRIEF DESCRIPTION OF THE DRAWINGS

FIG. 1 is a top perspective view of a cutting tool according to one embodiment of this invention.

FIG. 2 is a top view of the cutting tool shown in FIG. 1.

FIG. 3 is a side view of the cutting tool shown in FIG. 1.

FIG. 4 is a bottom view of the cutting tool shown in FIG. 1.

FIG. 5 is a front view of the cutting tool shown in FIG. 1.

FIG. 6 is a side view of the cutting tool shown in FIG. 1, showing the side opposite the side shown in FIG. 3.

FIG. 7 is a rear view of the cutting tool shown in FIG. 6.

FIG. 8 is a top perspective view of the cutting tool shown in FIG. 1 with a guide rail positioned parallel to a cutting blade.

FIG. 9 is a top view of the cutting tool shown in FIG. 8.

FIG. 10 is a top perspective view of the cutting tool shown in FIG. 1 with the guide rail positioned parallel to the cutting blade.

FIG. 11 is a top view of the cutting tool shown in FIG. 10.

FIG. 12 is a top perspective view of a guide rail according to one embodiment of this invention.

FIG. 13 is a bottom perspective view of the guide rail shown in FIG. 12.

### DESCRIPTION OF THE INVENTION

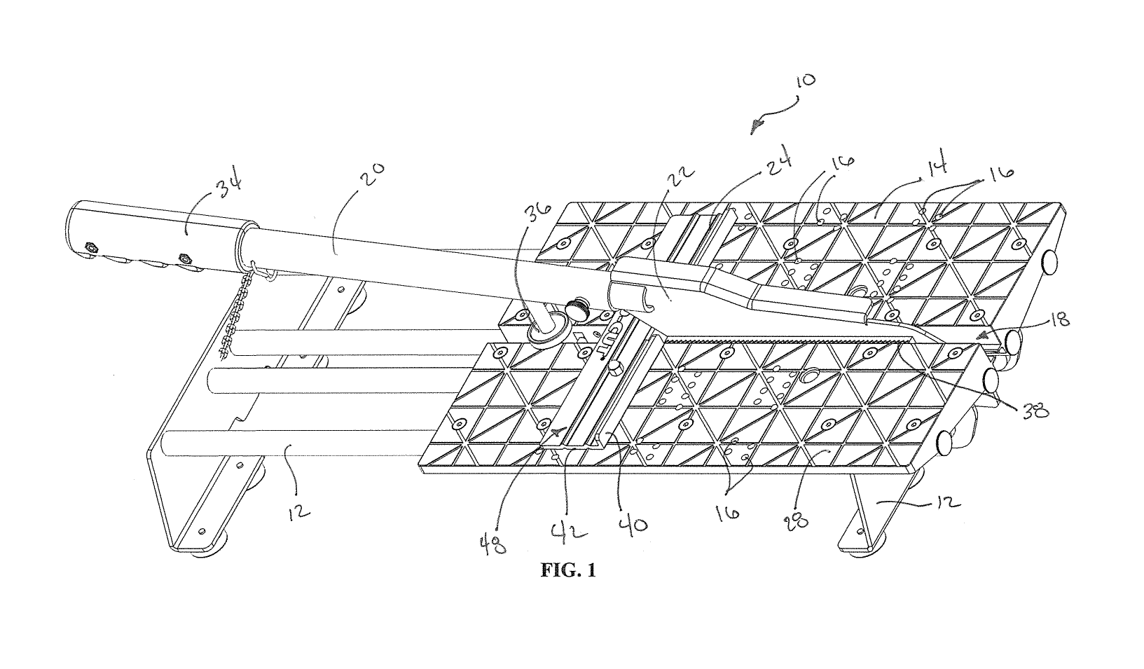

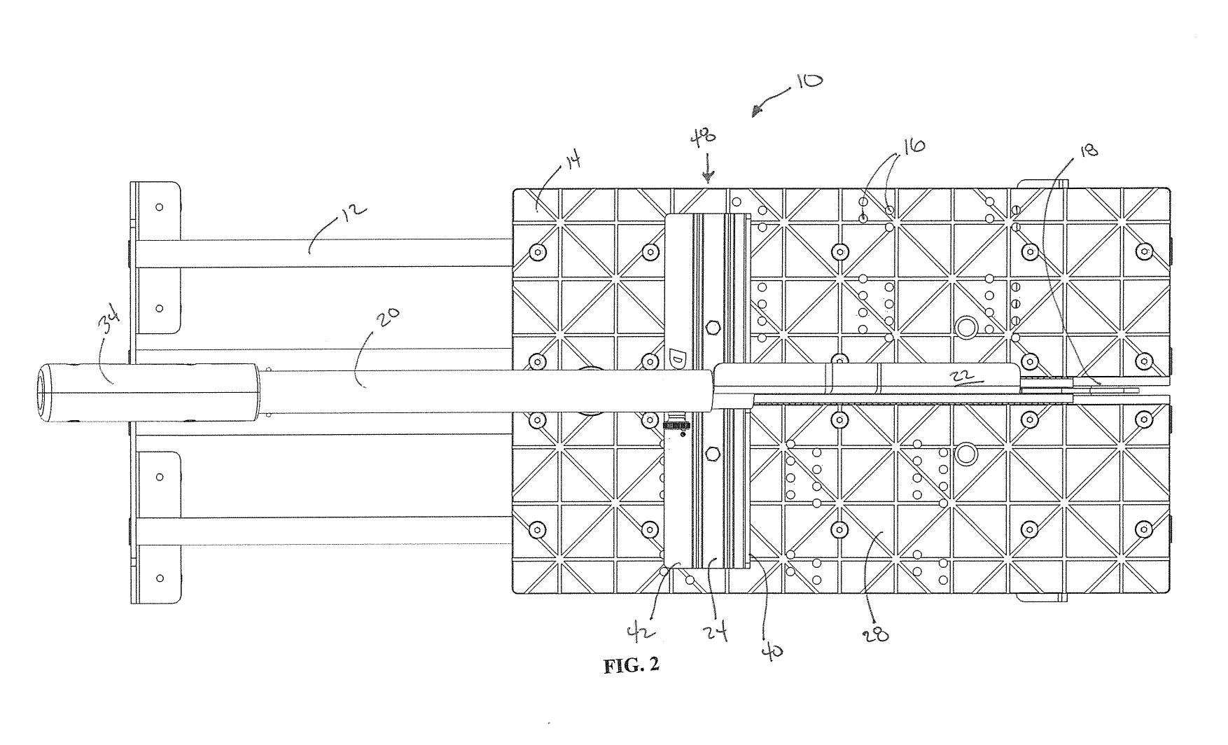

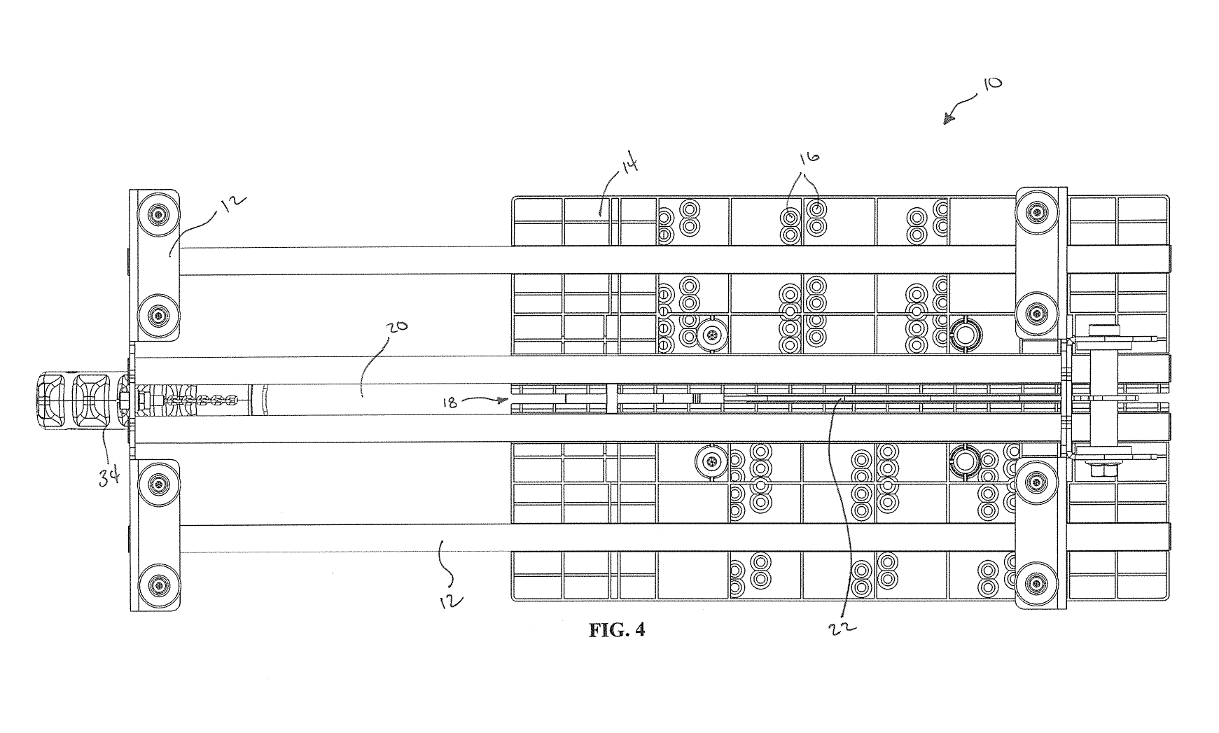

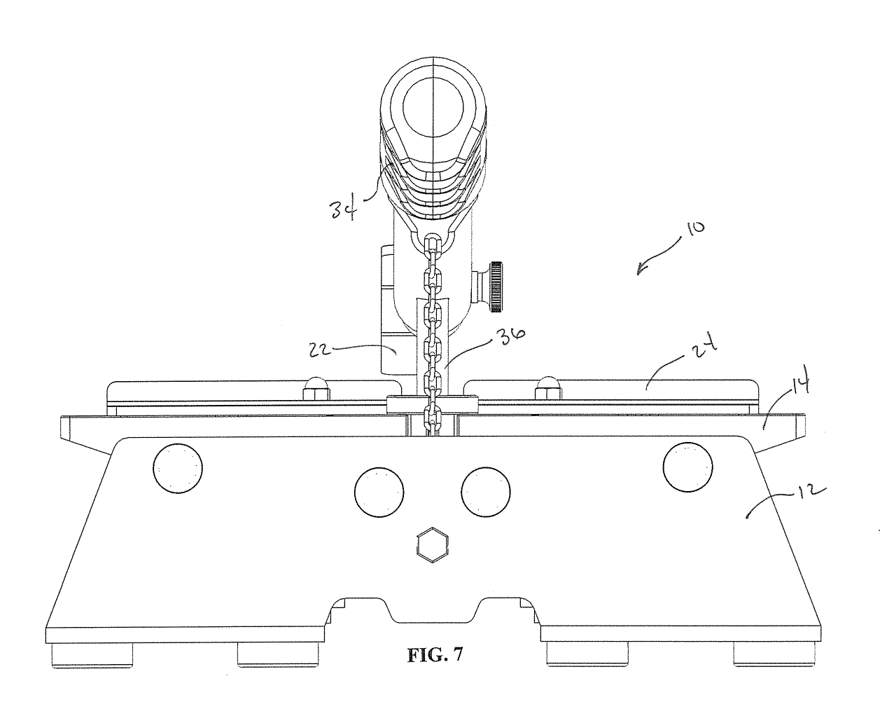

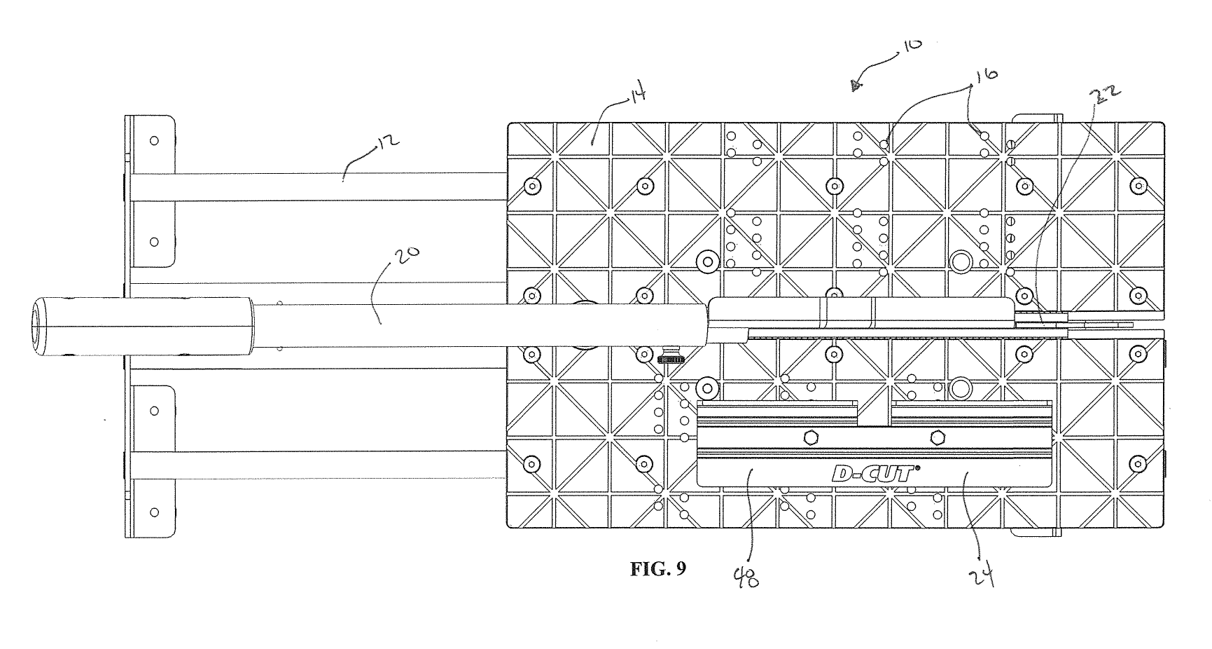

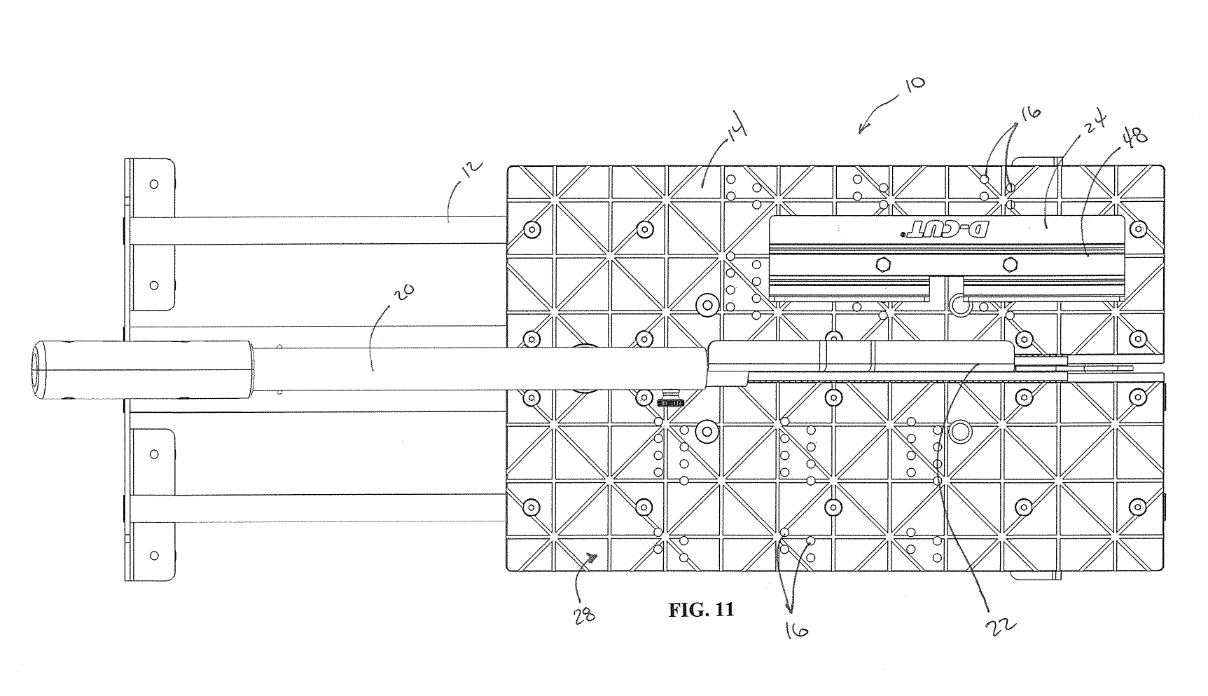

FIGS. 1-11 show a preferred embodiment of a cutting tool 10 of this invention. The cutting tool 10 of this invention preferably cuts polyvinyl chloride (PVC) and vinyl building materials including but not limited to flooring and trim. However, the cutting tool 10 may be used to cut other materials including, but not limited to, laminate, composite materials, wood, fiber board, fiber cement, rubber materials, and plastic materials.

The cutting tool 10 as described herein is desirably used to cut such building materials in a predictable and straight fashion without splintering, cracking or similar problems that may arise from such cuts. The cutting tool 10 of this invention is non-power operated and provides fast, dust-free cutting. A worker may utilize the cutting tool 10 according to this invention on a job site to cut flooring or similar materials to provide one or more cuts through the material for edges, corners and/or similar cuts required on a job site.

Those skilled in the art and following the teachings herein provided will appreciate that while the description below of various embodiments of a cutting tool of this invention refers to preferred configurations and uses, such configurations and uses are used for illustrative purposes only and may be modified as appropriate, depending on need.

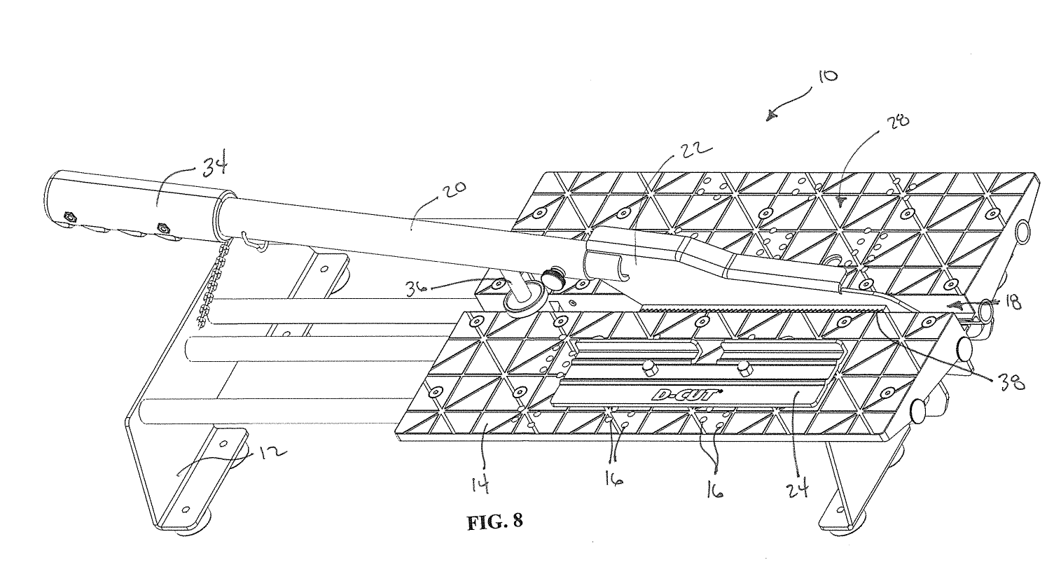

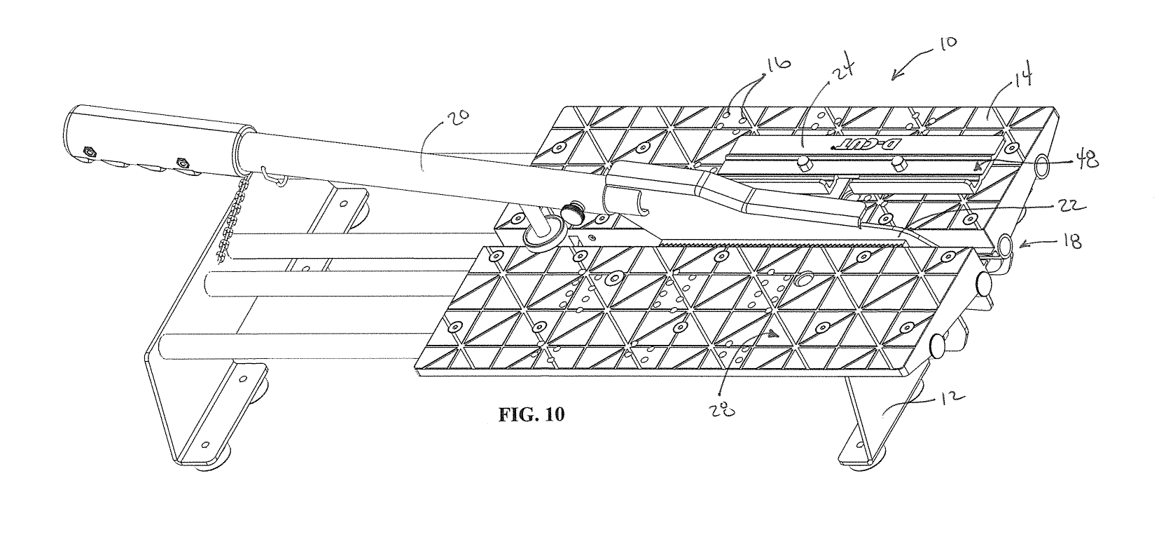

FIGS. 1-11 show a preferred embodiment of the invention comprising a small, compact cutting tool that permits foldability and storage. However, the cutting tool of this invention is not limited to this small, compact tool and may be larger or smaller. FIGS. 1-7 show the cutting tool 10 with a guide rail for lining up the material to be cut set perpendicular to a cutting plane of the blade. FIGS. 8 & 9 show the cutting tool with the guide rail set parallel to the cutting plane of the blade. FIGS. 10 & 11 show another embodiment of the cutting tool with the guide rail set parallel to the cutting plane of the blade.

In the embodiment of FIGS. 1-11, the cutting tool 10 for cutting a sheet of material, not shown, includes a base 12 and a working table 14 with a support surface 28. The working table 14 further includes a slot 18 extending through the working table 14 along at least a portion of the base 12.

According to one embodiment of this invention, the cutting tool 10 includes a blade 22 pivotally attached with respect to the base 12. The blade 22 further includes a handle 20 connected with respect to, or integrated with the blade 22 and a hand grip 34 formed with respect to, or integrated with, a distal end of the handle 20 and may include a knurled or gripped surface for a comfortable and positive grip. In an alternative embodiment, the handle may be pivotally attached with respect to the base and the blade is connected to the handle. In operation, the handle 20 and the blade 22 are pivotally movable with respect to the base 12 between an open position and a closed position. The blade 22 moves through the slot 18 in the working table 14 and works against an edge along the slot 18 to cut the building material as the blade 22 is moved from the open position to the closed position. In the closed position, the handle is closest to the base. In the open position, the handle is furthest away from the base.

A sheet of material is positionable on the support surface 28 for cutting. The support surface 28 desirably supports the sheet of material before and during cutting. In certain embodiments of this invention, the support surface 28 is generally flat with a grooved pattern to increase friction and to minimize movement of the material during cutting. In an alternative embodiment, the support surface may be shaped to complement the surface of a sheet of building material, or otherwise shaped, depending on use.

As shown in the figures, the base 12 may include four longitudinal beams arranged between two base support members. However, the base is not limited to this design and may comprise any design capable of supporting the material being cut. In the embodiment shown in the figures, the support members keep the working table 14 spaced from and suspended over the surface upon which the cutting tool 10 is placed for cutting, such as, for example, a ground, a floor or another surface. Such suspended configuration allows sufficient clearance for the blade 22 underneath the cutting tool and ensures that the blade 22 does not hit the ground or the floor when the blade 22 and the handle 20 is in the closed position and/or during the cutting process. The support members may further include a non-slip pads to prevent movement of the cutting tool 10 during the cutting process. The base 12 of this invention is preferably formed of steel or similar rigid material. However, any durable material capable of withstanding the force used to cut the material may be used.

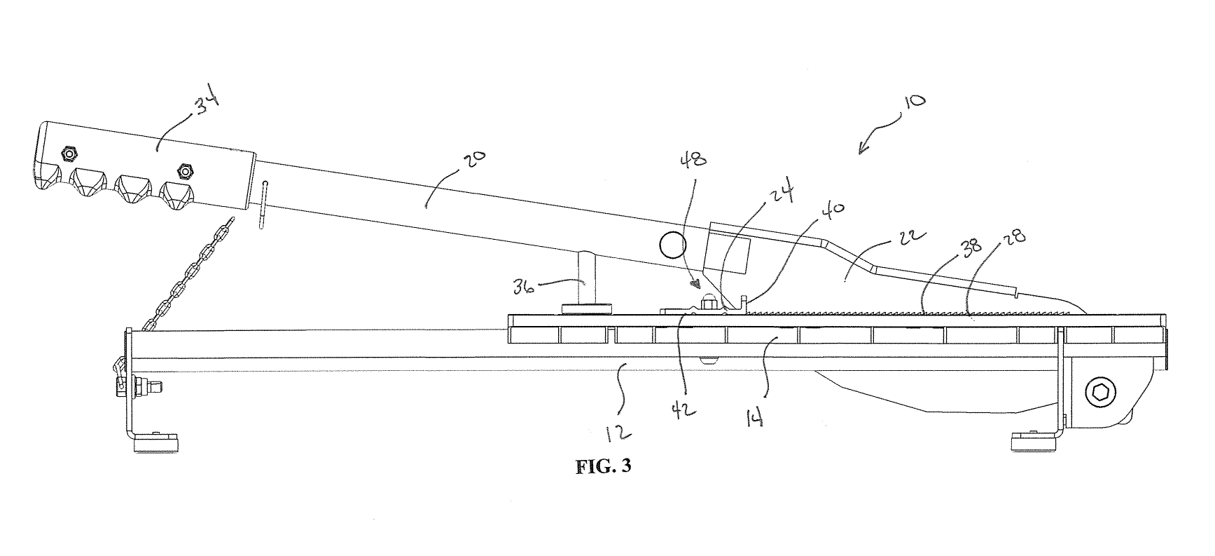

As shown in FIGS. 1 and 3, the handle 20 may further include a handle stop 36 extending away from the handle 20. The handle stop 36 may contact the base 12 following a full rotation of the handle 20 and thereby prevent the handle 20 from damaging either the base 12 or the sheet of material. In one embodiment of this invention, the handle stop 36 is a screw having a threaded shaft and a head. The threaded shaft is engageable with a threaded aperture in the handle, such that a portion of the screw extends from the handle 20 toward the base 12. The head of the screw may contact the base 12 when the handle 20 is in the closed position.

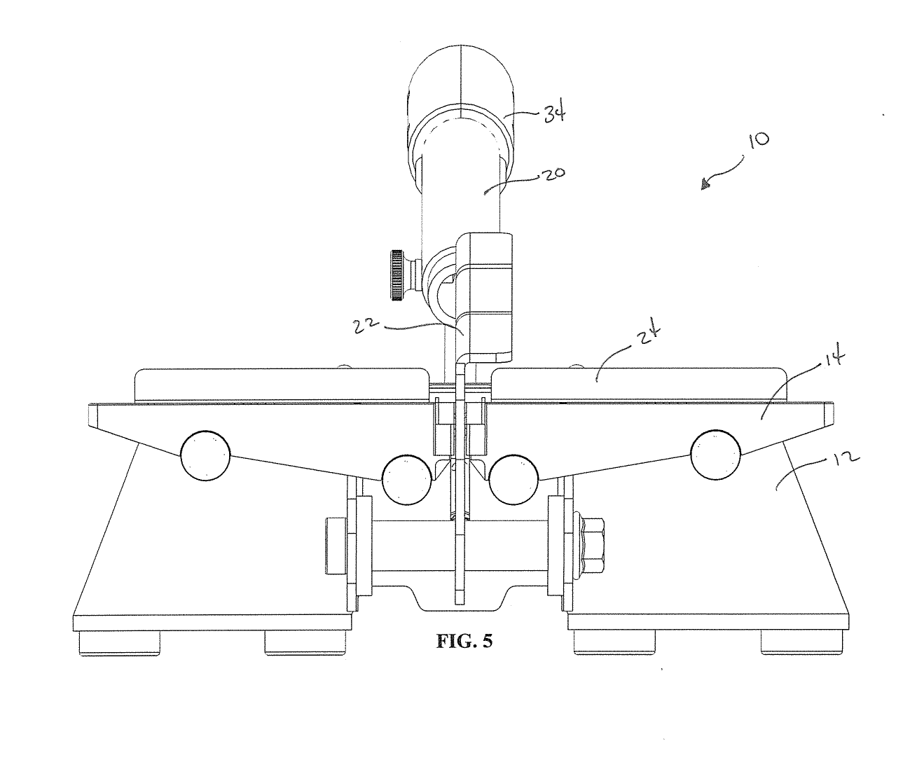

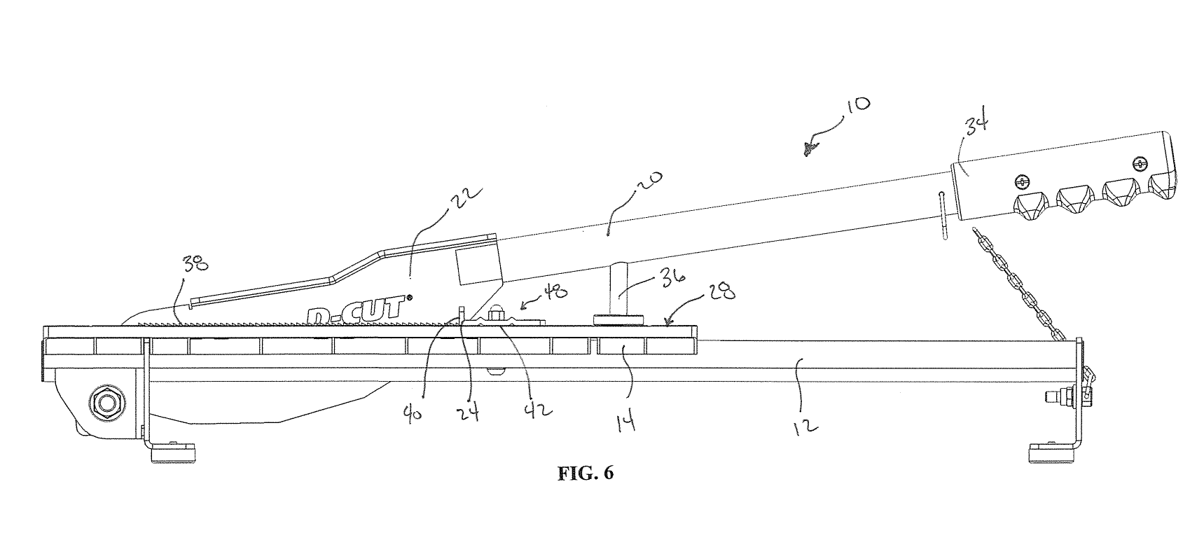

While many conventional cutting blades include a V-shaped cutting edge, the blade 22 of this invention preferably includes a plurality of generally flat cutting surfaces arranged in a polygonal profile. The polygonal profile is preferably a convex polygonal profile as shown in FIGS. 3 and 6. In one embodiment of this invention, each generally flat cutting surface is a straight segment having a length oriented in the longitudinal direction of the blade 22 and a width oriented perpendicular to the length, as best shown in FIG. 5. Each straight segment transitions, along its length, into at least one other straight segment and any two adjacent straight segments form an angle of between about 90 degrees and 180 degrees. In other words, the blade 22 preferably includes a plurality of generally flat cutting surfaces and preferably includes a polygonal profile comprising a series of straight transitions formed about a generally 180 degrees from the proximate end to a position in proximity to the handle 20. According to preferred embodiments of this invention, the series of generally straight segments comprising the profile of the blade 22 result in less work for a user than traditionally shaped cutting blades. In addition, the flat cutting surfaces of the blade 22 result in a somewhat wide clean cut across the sheet of material. The blade 22 is preferably formed of a steel material capable of repeatedly cutting all thicknesses and compositions of material.

In one embodiment of this invention, as shown in FIGS. 3 and 6, a top edge of the blade 22, opposite cutting surfaces, may also include a plurality of straight segments, similar to straight segments discussed above, arranged to form a polygonal profile. In one embodiment of this invention, the polygonal profile formed by the top edge of the blade 22 is a concave polygonal profile. In a preferred embodiment, the top edge of the blade 22 further includes a brace to improve the structural integrity of the blade 22.

According to certain preferred embodiments of this invention, the working table 14 includes a plurality of serrations 38 or a similar surface feature may be positioned on either side of the slot 18 in part to maintain a positive grip on the sheet of material prior to and during the cut. In one embodiment of this invention, the plurality of serrations 38 include a plurality of teeth, where a tip of each tooth is oriented toward the proximate end of the blade 22. In another embodiment of this invention, the plurality of serrations 38 include a plurality of teeth, where each tooth has a right-triangular profile, such that the right triangle is formed on the side of the tooth facing the proximate end of the blade 22. In some embodiments, a high friction material such as, for example, rubber or similar material may be positioned on the support surface 28 on one or both sides of the slot 18.

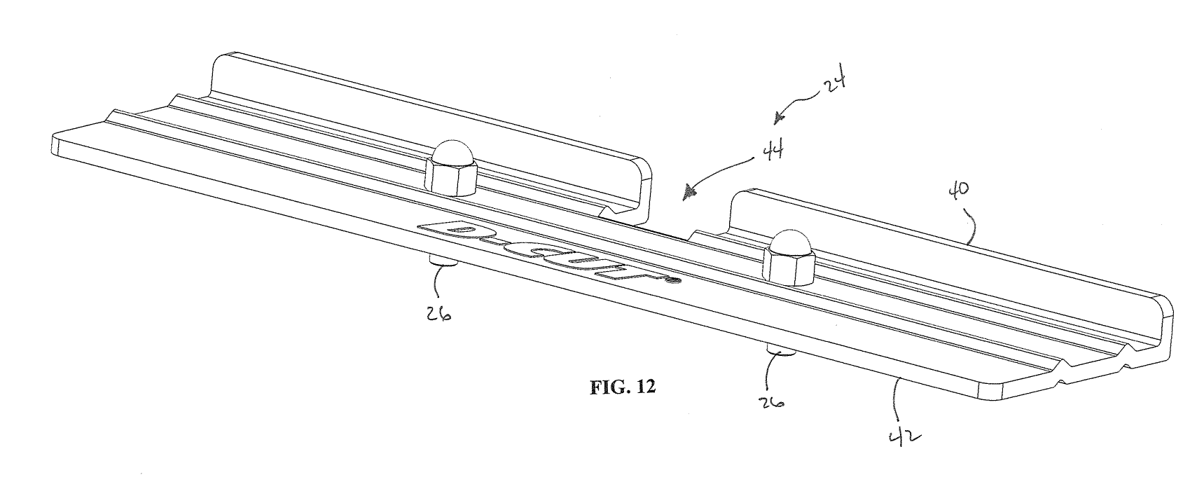

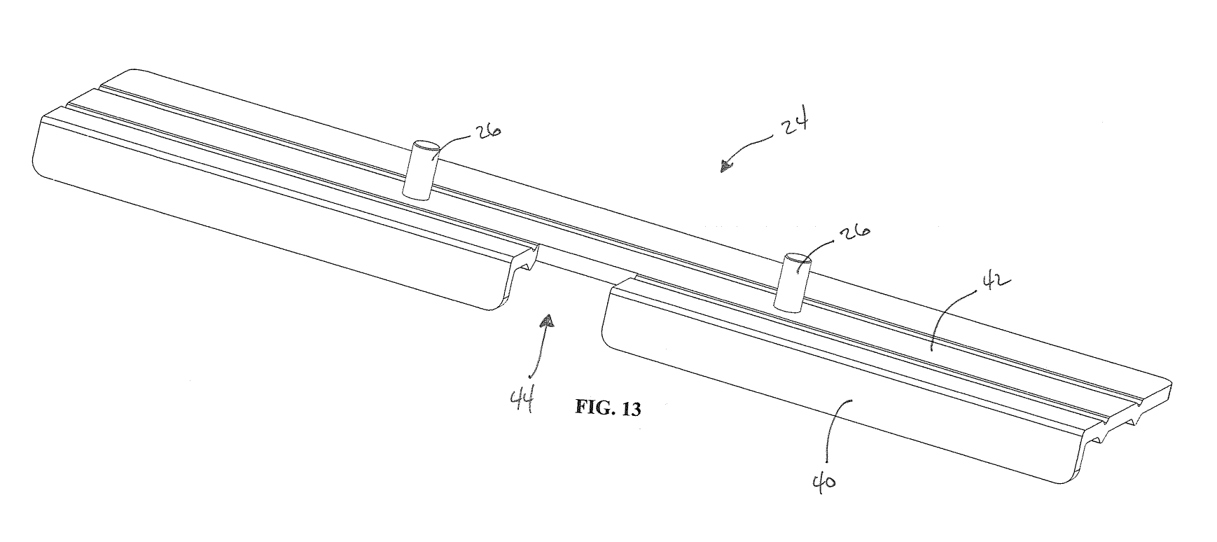

The cutting tool 10 of this invention further includes a guide rail 24. The guide rail 24 is preferably used to provide an engagement surface to align and support the material to be cut. According to one embodiment of this invention, as shown in FIGS. 12 and 13, the guide rail 24 comprises an L-shape and includes a rail body defining a material contact surface 40 and a base contact surface 42. The material contact surface 40 abuts and provides resistance to the sheet of material during cutting. The base contact surface 42 abuts the support surface 28 of the base 12. The guide rail 24 may further include an indentation 44 formed in the material contact surface 40 to provide clearance for the blade 22 and/or the handle 20 as the blade 22 moves between the open position and the closed position. In a preferred embodiment of this invention, the guide rail 24 further includes one or more connectors for attaching the guide rail 24 to the working table 14. In the embodiment of FIGS. 12 and 13, the connectors comprise a pair of posts 26, extending from the base contact surface 42 of the guide rail 24, that couple with the holes 16 in the working table to fix the guide rail in position. However, it should be understood that the connectors are not limited to this type of connector and may include any type of connector known to one of skill in the art including, but not limited to, threaded connectors, tab and groove connectors, or combinations of connectors.

In a preferred embodiment of the invention, the working table includes one or more engagement areas 48 for repositioning the guide rail 24 depending on the type of cut desired and/or the size and/or configuration of the building material material. The engagement areas 48 preferably allow the guide rail to be set at a variety positions relative to the blade 22. For example, as shown in FIGS. 1-7, the guide rail 24 may be set perpendicular to the cutting plane of blade 22. In another example, as shown in FIGS. 8-11, the guide rail 24 may be set parallel to the cutting plane of the blade 22.

In operation, a user would adjust the guide rail 24 into a desirable position on the working table 14, setting the guide rail 24 either perpendicular or parallel to the cutting plane of the blade and spaced from the blade with a desired spacing depending on the width of the cut. The handle 20 is raised up and away from the support surface 28, and then the sheet of material is positioned into place under the blade 22 and over the slot 18. Then the sheet of material would be positioned to firmly abut the material contact surface 40 of the guide rail 24 whereupon the handle 20 is lowered to cut the sheet of material in a desired fashion.

The invention illustratively disclosed herein suitably may be practiced in the absence of any element, part, step, component, or ingredient, which is not specifically disclosed herein.

While in the foregoing specification this invention has been described in relation to certain preferred embodiments thereof, and many details have been set forth for purpose of illustration, it will be apparent to those skilled in the art that the laminate cutter is susceptible to additional embodiments and that certain of the details described herein can be varied considerably without departing from the basic principles of the invention.

What is claimed is:

1. A cutting tool for cutting a material, the cutting tool comprising:
a working table positioned upon a base, the working table including a support surface and a slot extending at least partially through the working table;
a blade having a proximate end pivotally connected to the base, the blade movable with respect to the working table between an open position and a closed position and wherein the slot receives at least a portion of the blade when the blade is in the closed position; and
a guide rail including a material contact surface, wherein the guide rail is connectable to the working table in a plurality of positions including at least a perpendicular position and a parallel position, wherein in the perpendicular position the material contact surface is perpendicular to a cutting plane of the blade and the parallel position the material contact surface is parallel to the cutting plane of the blade.

2. The cutting tool of claim 1, wherein the guide rail includes a post and the working table includes a plurality of holes, and wherein the guide rail is connectable in one of the perpendicular position and the parallel position by inserting the post in one of the plurality of holes.

3. The cutting tool of claim 1, wherein the guide rail connects to the working table with a threaded fastener.

4. The cutting tool of claim 1, wherein the blade comprises a plurality of generally flat cutting surfaces arranged in a polygonal profile.

5. The cutting tool of claim 4, wherein each generally flat cutting surface is a straight segment, each straight segment transitioning into at least one other straight segment and two adjacent straight segments forming an angle of between about 90 degrees and 180 degrees.

6. The cutting tool of claim 1, wherein the support surface includes a plurality of serrations.

7. The cutting tool of claim 6, wherein the plurality of serrations are positioned in proximity to the slot.

8. The cutting tool of claim 1, wherein the support surface includes a high friction material.

9. The cutting tool of claim 1, wherein the support surface further includes markings for aligning a material to be cut.

10. The cutting tool of claim 1, further including a handle connected to the blade.

11. The cutting tool of claim 10, further including a handle stop extending from the handle toward the working table and contacting the working table when the blade is in the closed position.

12. A cutting tool for cutting a material, the cutting tool comprising:
a working table positioned upon a base, the working table including a support surface and a slot extending at least partially through the working table;
a handle having a proximate end pivotally engaged with respect to the base, the handle pivotally movable with respect to the base between an open position and a closed position;
a blade integrated with respect to the proximate end of the handle and wherein the slot receives at least a portion of the blade when the handle is in the closed position; and
a guide rail including a material contact surface, wherein the guide rail is connectable to the working table in a plurality of positions including at least a perpendicular position and a parallel position, wherein in the perpendicular position the material contact surface is perpendicular to a cutting plane of the blade and in the parallel position the material contact surface is parallel to the cutting plane of the blade.

13. The cutting tool of claim 12, wherein the guide rail includes a post and the working table includes a plurality of holes, and wherein the guide rail is connectable in one of the perpendicular position and the parallel position by inserting the post in one of the plurality of holes.

14. The cutting tool of claim 12, wherein the guide rail connects to the working table with a threaded fastener.

15. The cutting tool of claim 12, wherein the blade comprises a plurality of generally flat cutting surfaces arranged in a polygonal profile.

16. The cutting tool of claim 12, wherein each generally flat cutting surface is a straight segment, each straight segment transitioning into at least one other straight segment and two adjacent straight segments forming an angle of between about 90 degrees and 180 degrees.

17. A cutting tool for cutting a material, the cutting tool comprising:
a working table including a slot extending at least partially through the working table;
a blade movable with respect to the working table between an open position and a closed position, wherein the slot receives at least a portion of the blade when the blade is in the closed position; and
a guide rail including a material contact surface, wherein the guide rail is connectable to the working table in a plurality of positions.

18. The cutting tool of claim 17, wherein the plurality of positions include at least a perpendicular position and a parallel position, wherein in the perpendicular position the material contact surface is perpendicular to a cutting plane of the blade and in the parallel position the material contact surface is parallel to the cutting plane of the blade.

19. The cutting tool of claim 17, wherein the guide rail connects to the working table with a connector, wherein the connector comprises one of a post and hole connector, a tab and slot connector, and a threaded fastener.

20. The cutting tool of claim 17, wherein the blade comprises a plurality of generally flat cutting surfaces arranged in a polygonal profile.
